(19) United States
(12) Patent Application Publication
(10) Pub. No.: US 2024/0149604 A1
(43) Pub. Date: May 9, 2024

(54) SECURITY DEVICES AND METHODS OF PRODUCING THEM

(71) Applicant: OPSEC SECURITY LIMITED, Washington (GB)

(72) Inventors: Andrew ROWE, Leicestershire (GB); Robert RENTON, Lincolnshire (GB); Paul DUNN, Buckingham (GB)

(21) Appl. No.: 18/548,957

(22) PCT Filed: Mar. 10, 2022
(86) PCT No.: PCT/EP2022/056262

§ 371 Date: Sep. 5, 2023

(30) Foreign Application Priority Data
Mar. 11, 2021 (GB) 2103391.5

(51) Int. Cl. B42D 25/29; B42D 25/328; B42D 25/391

(52) U.S. Cl. CPC B42D 25/29; B42D 25/328; B42D 25/391

(57) ABSTRACT

A security device, including at least first and second embossed, reflective metal diffraction gratings in respective regions: wherein the first diffraction grating exhibits, in incident white light, a zero-order output over a first area of substantially uniform grating period, wherein the zero-order output of the first diffraction grating comprises different coloured first and second sub-outputs for respective first and second polarisations parallel and perpendicular to the first diffraction grating; wherein the second diffraction grating exhibits, in incident white light, a zero-order output over a second area of substantially uniform grating period; wherein the zero-order output of the second diffraction grating comprises third and fourth sub-outputs for respective first and second polarisations parallel and perpendicular to the second diffraction grating; and wherein the first and second diffraction gratings exhibit, for incident white light, substantially the same first order diffraction efficiency over the first and second areas.

The present invention relates to security devices used to authenticate the origin and/or integrity of objects or documents of which the device forms part or to which the device is applied.

### BACKGROUND

Diffraction gratings may be used in security devices to strengthen the security device against copying. Diffraction gratings exhibit at least first order diffraction outputs characterised by colours that change with viewing angle.

The inventors for the present application have had the idea of further strengthening a security device by configuring diffraction gratings of the security device such that the diffraction gratings exhibit zero-order outputs that are strikingly different when viewed through different polarisation filters, as a secondary covert diffraction feature supporting the primary overt diffraction feature that is the visible image created by first-order diffraction outputs of the diffraction gratings.

### SUMMARY

A security device, comprising at least first and second embossed, reflective metal diffraction gratings in respective regions: wherein the first diffraction grating exhibits, in incident white light, a zero-order output over a first area of substantially uniform grating period, wherein the zero-order output of the first diffraction grating comprises different coloured first and second sub-outputs for respective first and second polarisations parallel and perpendicular to the first diffraction grating; wherein the second diffraction grating exhibits, in incident white light, a zero-order output over a second area of substantially uniform grating period; wherein the zero-order output of the second diffraction grating comprises third and fourth sub-outputs for respective first and second polarisations parallel and perpendicular to the second diffraction grating; wherein the third sub-output is different to the first sub-output, and/or the fourth sub-output is different to the second sub-output; and wherein the first and second diffraction gratings exhibit, for incident white light, substantially the same first order diffraction efficiency over the first and second areas.

The sum of the first and second sub-outputs may be a coloured zero-order output.

The first and second sub-outputs may differ in terms of the respective order of output intensities at wavelengths of 420 nm, 530 nm and 560 nm.

One of the two sub-outputs may exhibit an output intensity ratio of greater than 1.3 between the output intensities at two of the 420 nm, 530 nm and 560 nm wavelengths, and the other of the two sub-outputs may exhibit an output intensity ratio of less than 0.8 between the output intensities at said two of the 420 nm, 530 nm and 560 nm wavelengths.

The first sub-output may exhibit an intensity difference of greater than 40 points on a 0-255 scale between the output intensities at said two of the 420 nm, 530 nm and 560 nm wavelengths, and the second sub-output may also exhibit an intensity difference of greater than 40 points on a 0-255 scale between the output intensities at said two of the 420 nm, 530 nm and 560 nm wavelengths.

The output intensities at said two of the 420 nm, 530 nm and 560 nm wavelengths may exhibit a relative swing between the first and second sub-outputs of at least 100 points on a 0-255 intensity scale.

The zero-order output of the second diffraction grating may comprise different coloured third and fourth sub-outputs for respective first and second polarisations parallel and perpendicular to the second diffraction grating; the colour of the third sub-output may be different to the colour of the first sub-output; and the colour of the fourth sub-output may be different to the colour of the second sub-output.

The sum of the third and fourth sub-outputs may have a different colour to the sum of the first and second sub-outputs.

The zero-order outputs of the first and second diffraction gratings may differ in terms of the order of output intensities at 420 nm, 530 nm and 560 nm wavelengths.

The grating period of the first diffraction grating may be different to the grating period of the second diffraction grating.

The first diffraction grating may have a substantially uniform aspect ratio over the first area, and the second diffraction grating may have a substantially uniform aspect ratio over the second area, and the first and second diffraction gratings may have the same aspect ratio.

The security device may further comprise a third diffraction grating, wherein the third diffraction grating may exhibit, in incident white light, over a third area of substantially uniform grating period, a diffraction output and a zero-order output without substantially any difference between fifth and sixth sub-outputs for respective first and second polarisations parallel and perpendicular to the third diffraction grating.

The third diffraction grating may exhibit, for incident white light, over the third area a first order diffraction efficiency that is substantially the same as the first order diffraction efficiency exhibited, for incident white light, over the first and second areas.

A security device, comprising at least first and second embossed, reflective metal diffraction gratings in respective regions; wherein the first diffraction grating exhibits, in incident white light, a zero-order output over a first area of substantially uniform grating period, wherein the zero-order output of the first diffraction grating comprises different coloured first and second sub-outputs for respective first and second polarisations parallel and perpendicular to the first diffraction grating; wherein the second diffraction grating exhibits, in incident white light, a zero-order output over a second area of substantially uniform grating period; wherein the zero-order output of the second diffraction grating comprises different coloured third and fourth sub-outputs for respective first and second polarisations parallel and perpendicular to the second diffraction grating; and wherein the colour of the third sub-output is different to the colour of the first sub-output; and wherein the colour of the fourth sub-output is different to the colour of the second sub-output; and wherein the first diffraction grating has a substantially uniform aspect ratio over the first area, and the second diffraction grating has a substantially uniform aspect ratio over the second area, and wherein the first and second diffraction gratings have the same aspect ratio.

A method of producing a security device, comprising: forming at least first and second reflective metal diffraction gratings in respective regions by a production process comprising embossing one or more grating profiles into a substrate; wherein the first diffraction grating exhibits, in incident white light, a zero-order output over a first area of substantially uniform grating period; wherein the zero-order output of the first diffraction grating comprises different coloured first and second sub-outputs for respective first and second polarisations parallel and perpendicular to the first diffraction grating; wherein the second diffraction grating exhibits, in incident white light, a zero-order output over a second area of substantially uniform grating period; wherein the zero-order output of the second diffraction grating comprises third and fourth sub-outputs for respective first and second polarisations parallel and perpendicular to the second diffraction grating; and wherein the third sub-output is different to the first sub-output, and/or the fourth sub-output is different to the second sub-output; and wherein the first and second diffraction gratings exhibit, in incident white light, substantially the same first order diffraction efficiency over the first and second areas.

A method of producing a security device comprising at least first and second reflective metal diffraction gratings in respective regions; wherein the method comprises: selecting for both first and second gratings a set of grating parameters that achieve substantially the same first order diffraction efficiency for visible light over a range of grating periods; and selecting grating periods for the first and second diffraction gratings from within said range of grating periods, taking into account at least a dependence on grating period of the overall diffraction efficiency for visible light.

A kit comprising a security device as described above, and at least one polarisation filter.

The kit may further include a viewer device comprising orthogonal polarisation filters secured side-by-side.

A method of testing the authenticity of a security device as described above, comprising: viewing the security device in sequence through orthogonal polarisation filters.

### BRIEF DESCRIPTION OF DRAWINGS

FIG. 1 shows a representation of the zero-order output and 1^{st} order diffraction outputs of a diffraction grating;

FIG. 2 shows a representation of the zero-order output of two diffraction gratings of a security device according to an example embodiment;

FIG. 3 shows a representation of three diffraction gratings of differing grating periods and identical aspect ratio in a security device according to an example embodiment;

FIG. 4 shows a representation of some compositional elements of a security device according to an example embodiment;

FIGS. 5 and 6 show a representation of a process of producing a security device according to an example embodiment; and

FIG. 7 shows a representation of a graph of zero-order output intensity vs. grating period for one polarisation in a technique of producing a security device according to an example embodiment;

FIG. 8 shows a representation of an example of an alternative, stepped shape/profile for the gratings, according to an example embodiment;

FIG. 9 shows a representation of another example of an alternative, stepped shape/profile for the gratings, according to an example embodiment;

FIG. 10 shows how the first order diffraction efficiency can vary with the number of steps N in the stepped shape/profiles of the kind shown in FIGS. 8 and 9.

### DETAILED DESCRIPTION

For the purpose of ease of explanation, the following description is provided for the example of a security device defining only two diffraction gratings of different grating period (grating constant), but the technique is equally applicable to the production of security devices defining many more diffraction gratings of respectively different grating periods. A security device according to some embodiments of the present invention may define diffraction gratings having the same grating period in distinct regions separated by one or more regions not defining any diffraction grating and/or define one or more diffraction gratings having different grating periods. A plurality of diffraction gratings may be arranged in a pattern representing an icon or mark familiar to the viewer, such as an icon or mark related to the product or document for which the security device provides authentication.

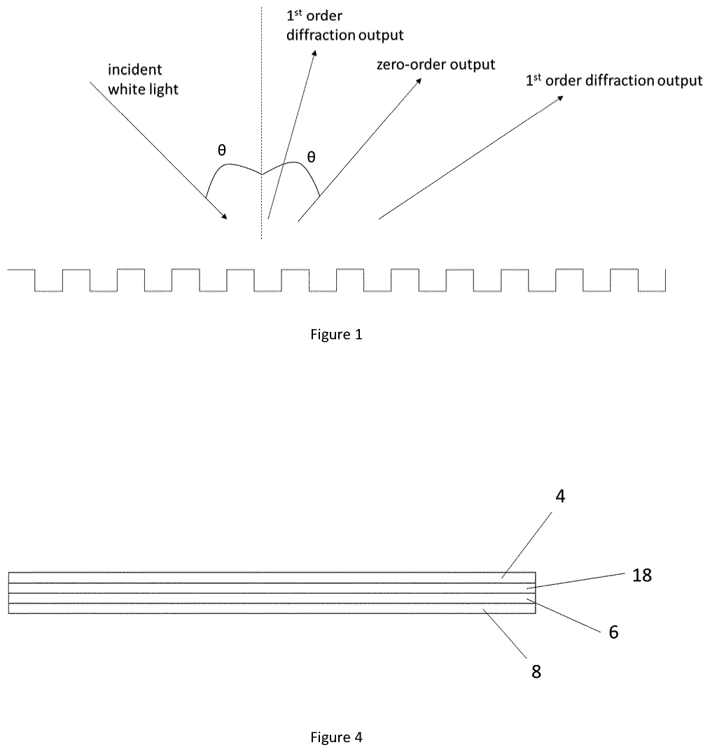

FIG. 1 shows a representation of the zero-order output and 1^{st}-order diffraction outputs for a diffraction grating in response to incident light. In addition to the 1^{st}-order diffraction outputs, the diffraction grating may exhibit 2^{nd}-order and higher order diffraction outputs.

FIG. 2 shows a representation of a security device 1 according to an embodiment of the present invention. The security device 1 defines two reflective metal diffraction gratings in two respective distinct regions 1A, 1B. The two diffraction gratings each exhibit a respective single grating period over the whole area of the respective region 1A, 1B. The grating period for one of the two diffraction gratings is different to the grating period for the other of the two diffraction gratings. In this example, one of the diffraction gratings has a period of 500 nm, and the other of the two diffraction gratings has a period of 600 nm. In other embodiments, the security device alternatively or additionally includes diffraction gratings having other periods less than about 1 micron, such as e.g., diffraction gratings having periods within the range of about 300 nm to 1100 nm, more particularly about 300 nm to 750 nm.

The two diffraction gratings are designed to exhibit substantially the same non-zero, first order diffraction efficiency for the same incident light in the visible spectrum, so as to provide a clean first-order visible diffraction image (created by the combination of the first-order diffraction outputs of the gratings) whose colours change with viewing angle.

FIG. 2 shows the zero-order output of the two diffraction gratings in response to incident white light. The zero-order output is shown in terms of the relative intensities on a linear 0-255 scale of the output intensities at short (S), medium (M) and long (L) wavelengths of 420 nm, 530 nm, 560 nm. These three wavelengths are the peak absorption wavelengths for the three different types of cones in the human eye. FIG. 2 shows: (a) the zero-order outputs of the diffraction gratings when viewed through a 90 degree polariser (S polarisation filter) that selectively transmits light having a polarisation at 90 degrees to the direction of the grating fringes; (b) the zero-order outputs of the diffraction gratings when viewed through a 0 degree polariser (P polarisation filter) that selectively transmits light having a polarisation at 0 degrees to the direction of the grating fringes; and (c) the sum of (a) and (b), as observed by the viewer without any intervening polariser (polarisation filter).

For each diffraction grating, the grating parameters are selected such that there is a striking contrast between the zero-order outputs for different polarisations. For each of the two diffraction gratings, the zero-order colour observed by the viewer through the polarisation filter is very different between the S and P polarisation filters. There is a change in the order of the output intensities at the L, M and S wavelengths between the two zero-order sub-outputs (the P sub-output and the S sub-output). For diffraction grating 1A, the order of output intensity (highest to lowest) is LMS for the S-polarisation and SML for the P-polarisation. For-hand diffraction grating 1B, the order of output intensity (highest to lowest) is LSM for the S-polarisation and LMS for the P-polarisation.

The striking contrast between the two polarisations is enhanced by a large swing in relative intensity between the output intensities at least two of the three LMS wavelengths. For diffraction grating 1A, the intensity ratio between the output intensities at the L and S wavelengths is about 2.2 (203/93) for the S polarisation and about 0.6 (133/215) for the P polarisation; and the change in intensity ratio between the two polarisations is about 1.6. For diffraction grating 1B, the intensity ratio between the output intensities at the M and S wavelengths is about 0.7 (114/157) for the S-polarisation and about 1.7 (192/112) for the P-polarisation; and the change in intensity ratio is about 1.0. A greater change in intensity ratio between the output intensities at two of the three LMS wavelengths can provide a yet further striking colour contrast between the two polarisations.

The striking change in output intensity for at least two of the three LMS wavelengths between the two polarisations can be expressed in terms of points on a linear 0-255 scale. For diffraction grating 1A, the output intensity at the L wavelength is 110 points more than the output intensity at the S wavelength for the S-polarisation, but is 82 points less than the output intensity at the S wavelength for the P-polarisation. This is an overall swing for the output intensities at the L and S wavelengths of 82+110=192 points between the two polarisations. Similarly, for diffraction grating 1B: the output intensity at the M wavelength is 43 points less than the output intensity at the S wavelength for the S-polarisation, but is 80 points more than the output intensity at the S wavelength for the P-polarisation. This is an overall swing for the output intensities at the M and S wavelengths of 43+80=123 points between the two polarisations. A greater change in the overall swing in the output intensities for at least two of the three LMS wavelengths between the two polarisations can provide a yet further striking colour contrast between the two polarisations.

The perception of a colour change between the two polarisations is enhanced, if for each S and P polarisation, the order of the output intensities at the LMS wavelengths is different between the zero-order outputs of the first and second diffraction gratings. Viewed through the S-polariser, the intensity order (from high to low) for diffraction grating 1A is LMS and the intensity order (from high to low) for diffraction grating 1B is LSM. Similarly, when viewed through the P-polariser, the intensity order (from high to low) for diffraction grating 1A is SML and the intensity order (from high to low) for diffraction grating 1B is LMS.

According to one example embodiment, the two diffraction gratings 1A, 1B have the same aspect ratio, and the aspect ratio is uniform over the whole area of each diffraction grating 1A, 1B. With reference to FIG. 3, the aspect ratio is defined as the ratio of the fringe width W to the depth D. The fringe width W is equal to half the period P; so the aspect ratio is also defined as the ratio of half the period (P/2) to the depth D. The use of two or more diffraction gratings having respective different grating periods P but having the same aspect ratio is illustrated in FIG. 3 for the example of three diffraction gratings of different grating periods. In the example shown in FIG. 3, the aspect ratio is about 1 for all of the three diffraction gratings. The size of the aspect ratio can be confirmed in the resulting security device using atomic force microscopy (AFM) or scanning electron microscopy (SEM).

According to one example embodiment, the security device additionally includes in at least one region (such as the border surrounding the two diffraction grating regions 1A and 1B in FIG. 2) at least one diffraction grating that exhibits first and higher order diffraction outputs, but whose zero-order output exhibits substantially no polarisation-dependence. The order of the output intensities at the LMS wavelengths is the same for both S and P polarisations, and/or there is no substantial change in the intensities at the LMS wavelengths between the S and P polarisations. The additional inclusion of one or more such diffraction gratings can further strengthen the security device against copying

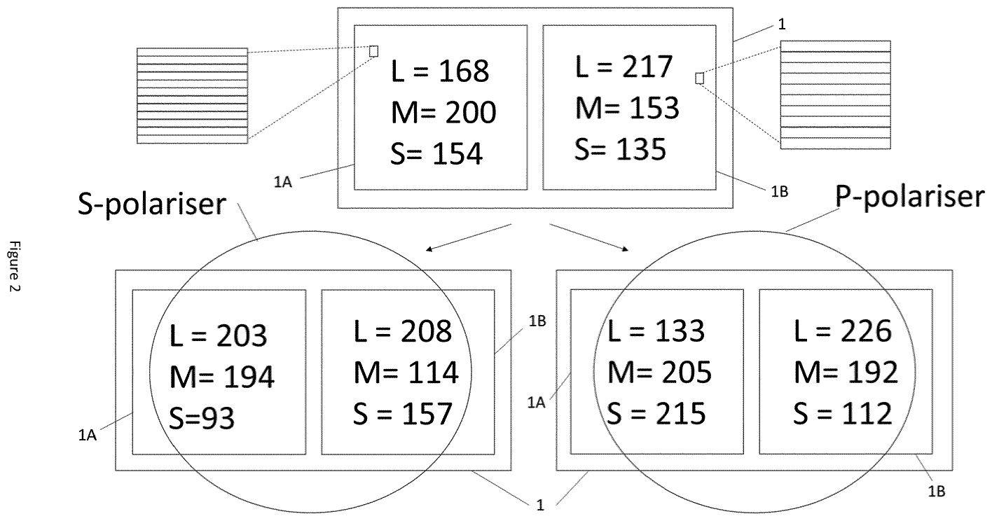

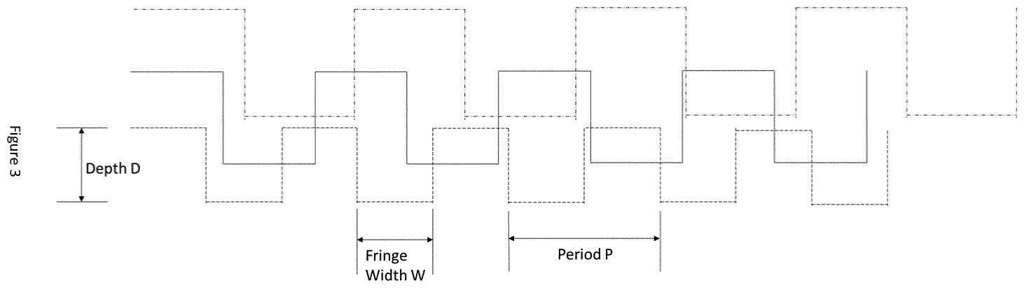

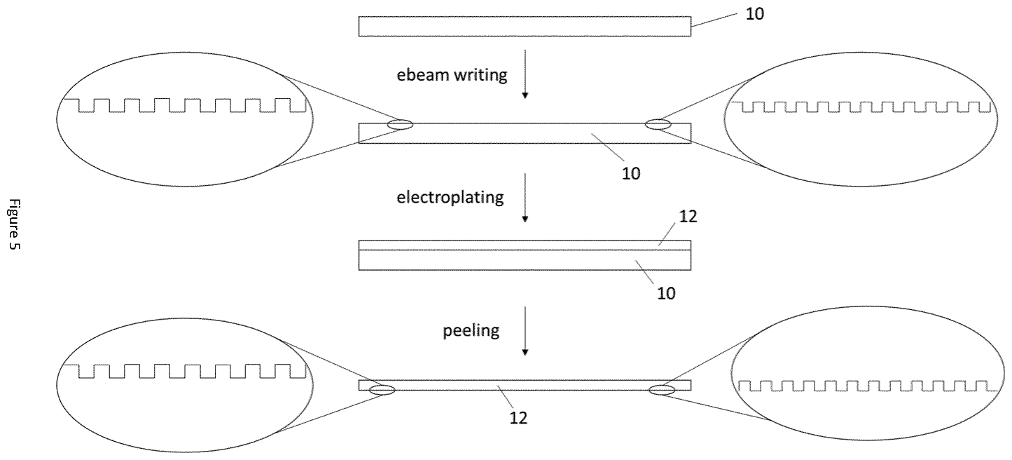

The security device 1 may form part of the product or document for which it provides authentication. Alternatively, the security device is produced as a sticker for post-manufacture application to a product or document. FIG. 4 shows a representation of example of such a sticker. The core of the sticker is a substrate 18 having an upper metallised surface defining one or more diffraction gratings of the kind described above. This upper surface is coated with a polymer material to define a transparent overcoating 4. Adhesive 6 is provided on the reverse (lower) side of the substrate 18, and a peelable release liner 8 protects the lower surface of the adhesive 6.

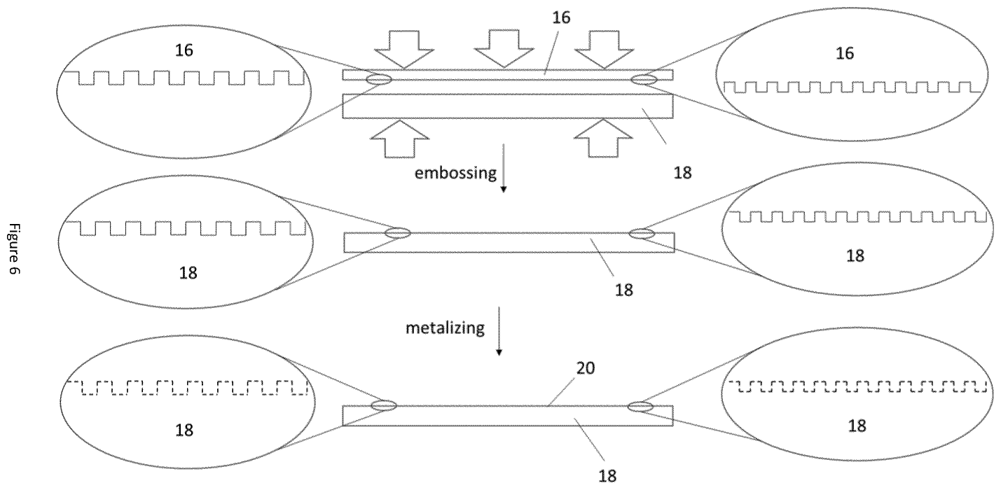

FIGS. 5 and 6 show representations of a method according to an example embodiment of producing a security device defining two diffraction gratings as described above, after selecting grating parameters for the diffraction gratings.

According to this example embodiment, the technique of selecting grating parameters to achieve the desired effect comprises: (i) determining a set of grating parameters (such as aspect ratio etc.) that produce substantially the same first order diffraction efficiency for the same incident light in the visible spectrum, and yet produce a significant difference in overall diffraction efficiency (for light in the visible spectrum) between the P and S polarisations over a range of grating periods less than 1 micron such as e.g. about 300 nm to 750 nm; and (ii) for that set of grating parameters, plotting graphs of zero-order output intensity vs. grating period for each of the P and S polarisations at each of the above-mentioned L, M and S wavelengths of white light; and (iii) selecting for one or more respective diffraction gratings of the security device respective one or more grating periods that produce the striking zero-order colour contrast between S and P polarisations. The selection of the grating constants can be facilitated by incorporating these graphs into physical optics design software such as, for example, the Virtual Lab Fusion software available from LightTrans GmbH to generate virtual representations of the zero-order sub-outputs, without having to produce a physical prototype.

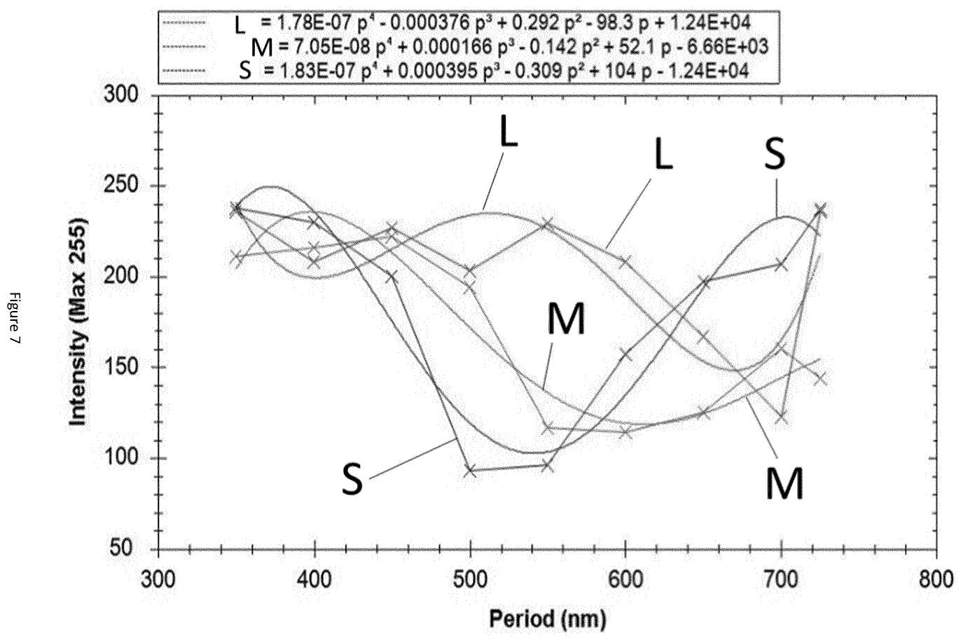

FIG. 7 shows an example of a graph of zero-order output intensity vs. grating period for the S polarisation (the polarisation for which the electric field vector is perpendicular to the direction in which the grating grooves extend) at each of the above-mentioned L, M and S wavelengths of white light. The dependence of the zero-order output intensity on grating period is less for the P polarisation (the polarisation for which the electric field vector is parallel to the direction in which the grating grooves extend)—the degree of fluctuation is much less than for the S-polarisation.

The intensity of the visible zero order output for a wavelength in the visible spectrum indicates the overall diffraction efficiency of the grating for that wavelength in the visible spectrum. The zero-order output colours observed by the viewer for incident white light are stable subtractive colours. The zero-order colour observed when the grating is viewed in white light through a polariser is the total incident visible light for that polarisation minus the part of the incident visible light of that polarisation that forms the first and higher order diffraction outputs.

According to this example embodiment, achieving substantially the same first order diffraction efficiency for two or more diffraction gratings involves using the same aspect ratio (e.g. about 1:1 or higher) for the two or more diffraction gratings and across the whole area of each diffraction grating (i.e. across the whole of each region for which the grating period is uniform). The existence of the polarisation-dependent zero order colour effects is then not evident from the first order diffraction outputs of the two gratings. In other words, designing the two gratings to have substantially the same first order diffraction efficiency for the visible spectrum serves to hide the existence of the polarisation-dependent zero-order colour effects. This covertness of the polarisation-dependent zero order colour effects further enhances the security function of the security device. The polarisation-dependent zero-order colour effects become a forensic detail that is only observable upon viewing the zero-order output in turn through a pair of orthogonal polariser filters or upon viewing the gratings in polarised incident light (such as the light emitted by a liquid crystal display (LCD) device). The above-described techniques comprise a one-step origination process involving seamlessly incorporating secondary covert diffraction features into the design of a diffraction grating for which a clean first-order diffraction image is the primary diffraction feature.

With reference to FIG. 5, profiles for the two diffraction gratings are created in the upper surface of an electron beam (e-beam) sensitive resist 10 (e.g. positive resist) by an e-beam writing technique comprising individual e-beam exposure of elements of the resist, and development of the resulting solubility pattern using an appropriate developer. As mentioned above, in this example, each diffraction grating is designed to have uniform parameters (grating period etc.) over the whole of the respective area that the diffraction grating occupies.

An advance Gaussian spot e-beam is used to expose the resist 10. Each fringe of each diffraction grating is divided into a two dimensional grid of elements each having a size equal to a single e-beam exposure. The length of time to which each element is exposed to the e-beam is calculated according to: (i) the required depth of the fringe, and (ii) to the non-linear relationship between e-beam exposure time and the depth to which the e-beam reduces the solubility of the positive e-beam resist. The calculation of the exposure time for each element also includes a proximity correction to take into account the proximity effect by which the e-beam exposure for one element contributes (according to a Monte Carlo distribution) some exposure to immediately neighbouring elements, and, to a lesser degree, more distant elements. The exposure time for an element is calculated so as to compensate for this contribution, so that the correct depth is achieved for the fringe.

In this example, the fringes and the periodicity are configured such that they can be divided into a whole number of grid elements exactly. This adds to the accuracy with which the profile can be achieved in the resist by avoiding areas of overlap in the exposure grids, which might otherwise cause areas of different depths. Some examples of side dimensions for each grid element are 10 nm, 25 nm and 50 nm.

In the case that some or all of the diffraction gratings are to be blazed or profiled gratings, one technique according to an example embodiment for exposing the e-beam resist comprises treating the volumes of the positive e-beam resist to be removed as a plurality of horizontal layers to be exposed in sequence. This sequence of exposures add together to give the required profile for the fringes. This technique involves calculating the proximity correction by calculating the Monte Carlo distribution of accumulated exposures of different intensities. One advantage of this incremental exposure technique is that any single error will only have a small contribution to the accumulated exposure required to give an accurate depth, and, with multiple exposures, can be self-correcting.

The upper surface is electroplated to produce a metal (e.g. nickel) layer 12 on the upper surface of the patterned resist, and the nickel layer 12 is then peeled from the resist 10. This nickel replica 12 of the resist 10 is then used to make intermediate masters, and these intermediate masters are used to produce one or more embossing shims 16.

With reference to FIG. 6, the profiled surface of the embossing shim 16 is mechanically pressed into a surface of a substrate 18 (such as e.g., a plastic or paper substrate) to reproduce in the surface of the substrate 18 a profile defining the diffraction gratings 1A, 1B. A thin layer of metal (e.g., aluminium) 20 is formed in-situ on the profiled surface of the substrate 18 by a vapour deposition process.

The detailed description above uses the example of gratings having square-wave profiles, but the gratings may have other profile shapes. For grating profiles in which the fringe depth varies across the fringe width, the aspect ratio is defined as the ratio of the fringe width to the maximum fringe depth; and as mentioned above, the aspect ratio is about 1 or higher in the examples described above.

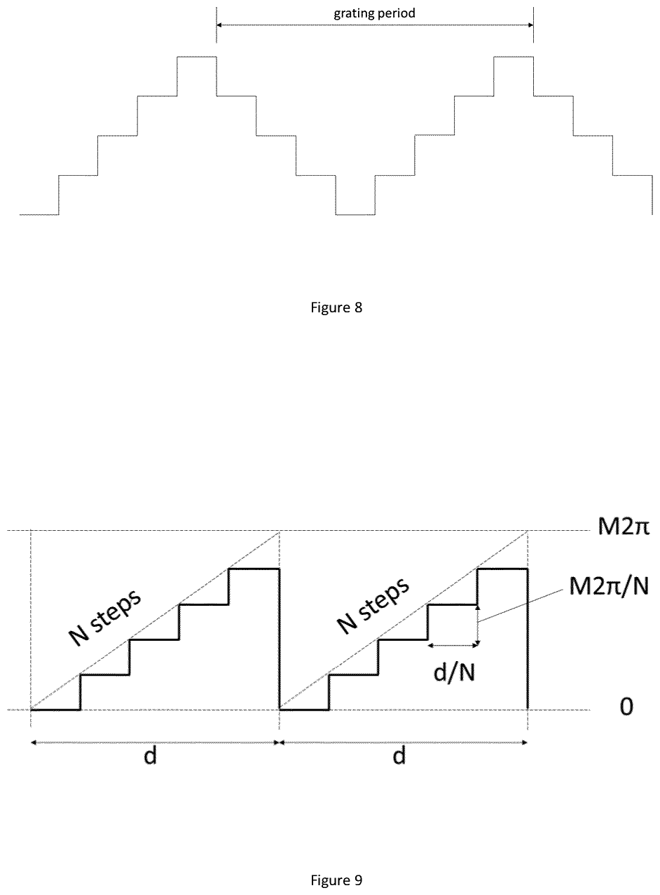

FIGS. 8 and 9 show representations of examples of alternative, stepped profiles for the gratings. For stepped phase gratings, the Fourier series coefficient of this stepped phase grating is given by the following equation, in which: d, N and M are parameters indicated by FIG. 9.

$${C}_{∝} = \frac{1}{d} {\sum }_{N = 0}^{N - 1} ( {\int }_{nd / N}^{( n + 1 ) d / N} {e}^{- iM 2 π n / N} {e}^{i ∝ 2 π x / d} dx )$$

From this equation, the following coefficients may be derived as follows:

$${C}_{∝} = {e}^{i \frac{πα}{N}} \frac{{e}^{- i π ( M - α )}}{{e}^{- i \frac{π}{N} ( M - α )}} \cdot \frac{sin ( \frac{πα}{N} )}{πα} \cdot \frac{sin ( π ( M - α ) )}{sin ( \frac{π}{N} ( M - α ) )}$$

The relative efficiency at each diffraction order may be expressed as:

$${η}_{α} ( M , N ) = {\vert {c}_{α} \vert}^{2} = {( \frac{sin ( \frac{πα}{N} )}{πα} )}^{2} {( \frac{sin ( π ( M - α ) )}{sin ( \frac{π}{N} ( M - α ) )} )}^{2}$$

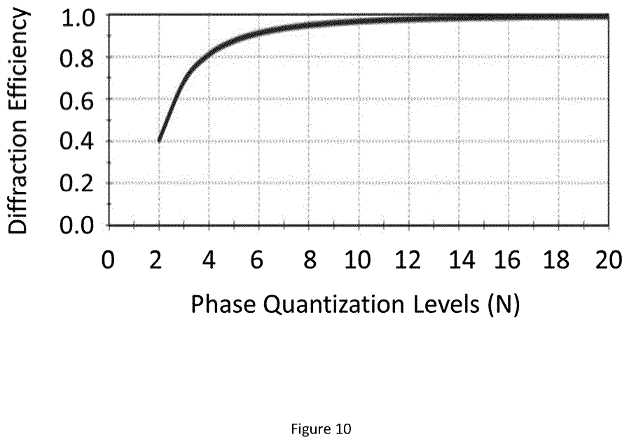

FIG. 10 shows how the first order diffraction efficiency may be dependent on the number of phase quantization levels (N). In this example, the first order diffraction efficiency is about 40% for N=2 (binary phase grating), about 68% for N=3, and reaches more than 91% for N=6 and higher.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A security device, comprising at least first and second embossed, reflective metal diffraction gratings in respective regions:
wherein the first diffraction grating exhibits, in incident white light, a zero-order output over a first area of substantially uniform grating period, wherein the zero-order output of the first diffraction grating comprises different colored first and second sub-outputs for respective first and second polarisations parallel and perpendicular to the first diffraction grating;
wherein the second diffraction grating exhibits, in incident white light, a zero-order output over a second area of substantially uniform grating period; wherein the zero-order output of the second diffraction grating comprises third and fourth sub-outputs for respective first and second polarisations parallel and perpendicular to the second diffraction grating; wherein the third sub-output is different to the first sub-output, and/or the fourth sub-output is different to the second sub-output; and
wherein the first and second diffraction gratings exhibit, for incident white light, substantially the same first order diffraction efficiency over the first and second areas.

2. The security device according to claim 1, wherein the sum of the first and second sub-outputs is a coloured zero-order output.

3. The security device according to claim 1, wherein the first and second sub-outputs differ in terms of the respective order of output intensities at wavelengths of 420 nm, 530 nm and 560 nm.

4. The security device according to claim 3, wherein one of the two sub-outputs exhibits an output intensity ratio of greater than 1.3 between the output intensities at two of the 420 nm, 530 nm and 560 nm wavelengths, and the other of the two sub-outputs exhibits an output intensity ratio of less than 0.8 between the output intensities at said two of the 420 nm, 530 nm and 560 nm wavelengths.

5. The security device according to claim 3, wherein the first sub-output exhibits an intensity difference of greater than 40 points on a 0-255 scale between the output intensities at said two of the 420 nm, 530 nm and 560 nm wavelengths, and the second sub-output also exhibits an intensity difference of greater than 40 points on a 0-255 scale between the output intensities at said two of the 420 nm, 530 nm and 560 nm wavelengths.

6. The security device according to claim 3, wherein the output intensities at said two of the 420 nm, 530 nm and 560 nm wavelengths exhibit a relative swing between the first and second sub-outputs of at least 100 points on a 0-255 intensity scale.

7. The security device according to claim 1, wherein the zero-order output of the second diffraction grating comprises different coloured third and fourth sub-outputs for respective first and second polarisations parallel and perpendicular to the second diffraction grating; and wherein the colour of the third sub-output is different to the colour of the first sub-output; and wherein the colour of the fourth sub-output is different to the colour of the second sub-output.

8. The security device according to claim 7, wherein the sum of the third and fourth sub-outputs has a different colour to the sum of the first and second sub-outputs.

9. The security device according to claim 7, wherein the zero-order outputs of the first and second diffraction gratings differ in terms of the order of output intensities at 420 nm, 530 nm and 560 nm wavelengths.

10. The security device according to claim 1, wherein the grating period of the first diffraction grating is different to the grating period of the second diffraction grating.

11. The security device according to claim 1, wherein the first diffraction grating has a substantially uniform aspect ratio over the first area, and the second diffraction grating has a substantially uniform aspect ratio over the second area, and wherein the first and second diffraction gratings have the same aspect ratio.

12. The security device according to claim 1, further comprising a third diffraction grating, wherein the third diffraction grating exhibits, in incident white light, over a third area of substantially uniform grating period, a diffraction output and a zero-order output without substantially any difference between fifth and sixth sub-outputs for respective first and second polarisations parallel and perpendicular to the third diffraction grating.

13. The security device according to claim 12, wherein the third diffraction grating exhibits, for incident white light, over the third area a first order diffraction efficiency that is substantially the same as the first order diffraction efficiency exhibited, for incident white light, over the first and second areas.

14. A security device, comprising at least first and second embossed, reflective metal diffraction gratings in respective regions;
wherein the first diffraction grating exhibits, in incident white light, a zero-order output over a first area of substantially uniform grating period, wherein the zero-order output of the first diffraction grating comprises different coloured first and second sub-outputs for respective first and second polarisations parallel and perpendicular to the first diffraction grating;
wherein the second diffraction grating exhibits, in incident white light, a zero-order output over a second area of substantially uniform grating period; wherein the zero-order output of the second diffraction grating comprises different coloured third and fourth sub-outputs for respective first and second polarisations parallel and perpendicular to the second diffraction grating; and wherein the colour of the third sub-output is different to the colour of the first sub-output; and wherein the colour of the fourth sub-output is different to the colour of the second sub-output; and
wherein the first diffraction grating has a substantially uniform aspect ratio over the first area, and the second diffraction grating has a substantially uniform aspect ratio over the second area, and wherein the first and second diffraction gratings have the same aspect ratio.

15. A method of producing a security device, comprising:
forming at least first and second reflective metal diffraction gratings in respective regions by a production process comprising embossing one or more grating profiles into a substrate;
wherein the first diffraction grating exhibits, in incident white light, a zero-order output over a first area of substantially uniform grating period; wherein the zero-order output of the first diffraction grating comprises different coloured first and second sub-outputs for respective first and second polarisations parallel and perpendicular to the first diffraction grating;
wherein the second diffraction grating exhibits, in incident white light, a zero-order output over a second area of substantially uniform grating period; wherein the zero-order output of the second diffraction grating comprises third and fourth sub-outputs for respective first and second polarisations parallel and perpendicular to the second diffraction grating; and wherein the third sub-output is different to the first sub-output, and/or the fourth sub-output is different to the second sub-output; and
wherein the first and second diffraction gratings exhibit, in incident white light, substantially the same first order diffraction efficiency over the first and second areas.

16. A method of producing a security device comprising at least first and second reflective metal diffraction gratings in respective regions; wherein the method comprises:
selecting for both first and second gratings a set of grating parameters that achieve substantially the same first order diffraction efficiency for visible light over a range of grating periods; and
selecting grating periods for the first and second diffraction gratings from within said range of grating periods, taking into account at least a dependence on grating period of the overall diffraction efficiency for visible light.

17. A kit comprising the security device according to claim 1, and at least one polarisation filter.

18. The kit according to claim 17, further including a viewer device comprising orthogonal polarisation filters secured side-by-side.

19. A method of testing the authenticity of the security device of claim 1, comprising: viewing the security device in sequence through orthogonal polarisation filters.
